(19) United States
(12) Patent Application Publication
(10) Pub. No.: US 2024/0176337 A1
(43) Pub. Date: May 30, 2024

(54) INDUSTRIAL QUALITY MONITORING SYSTEM WITH PRE-TRAINED FEATURE EXTRACTION

(71) Applicant: Robert Bosch GmbH, Stuttgart (DE)

(72) Inventors: Felipe CONDESSA, Pittsburgh, PA (US); Devin WILLMOTT, Pittsburgh, PA (US); Ivan BATALOV, Pittsburgh, PA (US); João D. SEMEDO, Pittsburgh, PA (US); Wan-Yi LIN, Wexford, PA (US); Bahare AZARI, San Jose, CA (US)

(21) Appl. No.: 18/072,220

(22) Filed: Nov. 30, 2022

(51) Int. Cl. G05B 19/418

(52) U.S. Cl. CPC G05B 19/41875; G05B 2219/32368

(57) ABSTRACT

Methods and systems for classifying a article of manufacture are disclosed. A classifier is trained with training data including 1) a feature vector related to the article based on measurements related to the article captured at a particular station of a manufacturing process and 2) encoded time series data representing a history of measurements of articles of the same type as the article of manufacture captured at a sequence of stations of the manufacturing process prior to the particular station.

### TECHNICAL FIELD

The present disclosure relates to methods and systems for training a classifier to classify articles of manufacture. The trained classifier may be used to monitor articles of manufacture during a process of manufacturing the article.

### BACKGROUND

During a process of manufacturing an article, measurements may be taken of the article being manufactured. The article may be an article of manufacture. The article may be a product being manufactured or a part of a product being manufactured. These measurements may be taken by one or more sensors at one or more stations of a facility performing the manufacturing process. There may be a plurality of kinds or types of sensors measuring a plurality of characteristics of the article being manufactured. For example, the plurality of sensors may include cameras that capture imagery data; audio equipment that capture audio data; and sensors that capture data related to dimensions, strength, roughness, or temperature of the article during the manufacturing process. One or more measurements captured at each station may be used, for example, to monitor the quality of an article during a manufacturing process. One or more measurements related to an article captured at a station in a sequence of stations of a manufacturing process may be input into a classifier to produce an output. The output may be a classification of the article that is indicative of whether an article is faulty or otherwise anomalous, for example.

### SUMMARY

The output of the classifier in prior proposals is based only on the measurement(s) obtained from one or more sensors at a station of a manufacturing process. That is, the classifier does not consider the history of measurement data captured by one or more sensors at one or more stations of the manufacturing process prior to the station.

In one or more embodiments, the present disclosure describes classifying an article by applying a classifier to an input comprising an aggregation of a feature vector of an article with an encoding of time series data representing a history of measurements of articles of the same type as the article. The feature vector of the article may be extracted from measurement data captured at a station (e.g., location) in the manufacturing process. The time series data may comprise measurements captured at a sequence of prior stations of the manufacturing process. The present disclosure includes a description of embodiments related to manufacturing processes.

Some embodiments of methods for classifying an article of manufacture disclosed herein comprise receiving measurements related to an article of manufacture, the measurements being captured at a station in a manufacturing process; applying a feature extractor to the received measurements to generate a feature vector of the article; aggregating the feature vector of the article with encoded time series data representing a history of measurements of articles of the same type as the article of manufacture captured at a sequence of stations of the manufacturing process prior to the station to generate an input to a classifier; and applying the classifier to the input to produce a classification of the article of manufacture.

Some embodiments of systems for classifying an article of manufacture disclosed herein comprise one or more processors; and one or more non-transitory memories communicatively connected to the one or more processors, the one or more memories including computer-executable instructions that when executed cause the system to perform one or more of the methods disclosed herein.

Some embodiments of methods for training a classifier to classify articles of manufacture disclosed herein comprise generating training data for the classifier, the training data including a plurality of training data pairs, wherein each of the plurality of training data pairs includes an input to the classifier and a predetermined output that the classifier is being trained to produce when the classifier is applied to the input, and wherein each input in the plurality of inputs in the plurality of training data pairs includes an aggregation of: a feature vector of an article of manufacture based on one or more measurements related to the article captured at a station of a manufacturing process; and an encoding of time series data representing a history of measurements of articles of the same type as the article of manufacture captured at a sequence of stations of the manufacturing process prior to the station; and iteratively adjusting parameters of the classifier by reducing an error in the outputs of the classifier generated when the classifier is applied to each of the inputs in the training data pairs.

Some embodiments of systems for training a classifier disclosed herein comprise one or more processors; and one or more non-transitory memories communicatively connected to the one or more processors, the one or more memories including computer-executable instructions that when executed cause the system to perform one or more of the methods disclosed herein.

### BRIEF DESCRIPTION OF THE DRAWINGS

FIG. 1 discloses an example system for classifying an article of manufacture in accordance with embodiments disclosed herein.

FIG. 2 discloses an example computing system for performing embodiments of methods disclosed herein.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present embodiments. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

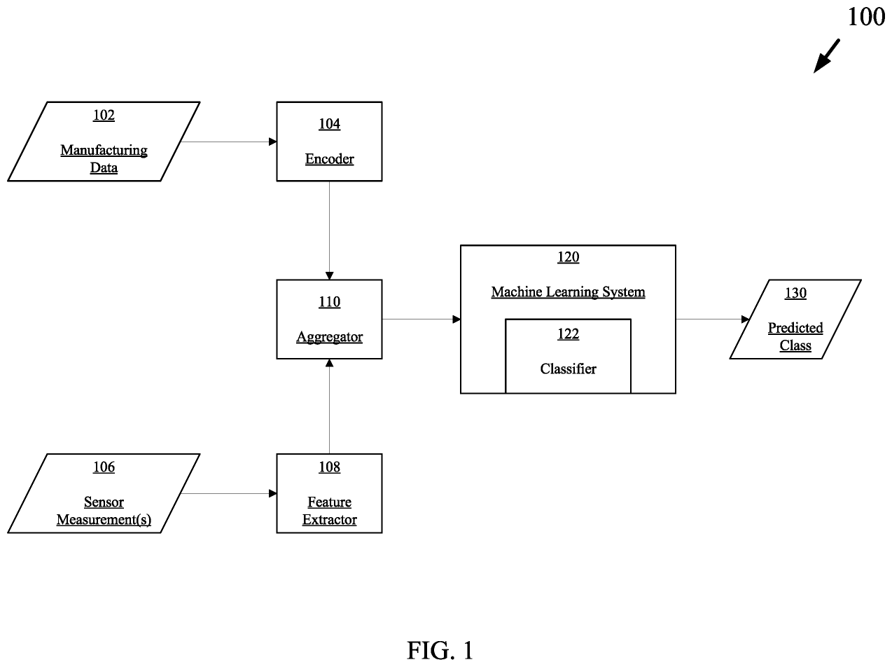

FIG. 1 discloses an example system for classifying an article of manufacture in accordance with embodiments disclosed herein. FIG. 1 discloses a feature extractor 108 that may receive one or more sensor measurements 106 related to the article of manufacture. In some embodiments, the sensor measurements 106 are measurements captured by one or more sensors at a particular station of a manufacturing process. Each of the one or more sensors may be, for example, a camera, an acoustic sensor, a pressure sensor, an ultrasound sensor, or spectroscopy equipment. The sensor measurement(s) 106 may vary depending on the particular embodiment being implemented. In some embodiments, the sensor measurement(s) 106 may be a single measurement, such as a dimension (e.g., length, height, width, weight, temperature, sound volume, pressure) related to the article. When the sensor measurement(s) 106 comprise a single measurement, the single measurement may be input to the feature extractor 108 to produce an output of the feature extractor 108. In some embodiments, the sensor measurement(s) 106 may be a plurality of measurements. For example, the sensor measurement(s) 106 may include a plurality of dimensions related to the article. In some embodiments, the sensor measurement(s) 106 may include one or more two-dimensional values, such as images.

When the sensor measurement(s) 106 include a plurality of values captured by a plurality of sensors at a particular time, the plurality of measurements may be aggregated to generate an input to the feature extractor 108. The aggregation of the plurality of measurements may include a concatenation of the plurality of measurements. For example, if the plurality of measurements includes a height of H, a width W, and a length L, the measurements may be concatenated to generate an input comprising a one-dimensional vector having three elements (e.g., H, W, L). In some embodiments, sensor fusion techniques may be used to aggregate a plurality of sensor measurements into an input to the feature extractor 108. In some embodiments, the feature extractor 108 may comprise sensor fusion techniques to aggregate a plurality of sensor measurements and generate a feature vector of the article that may be input to aggregator 110. The feature extractor 108 may generate a feature vector of the article that may be input to the aggregator 110. A feature vector generated by the feature extractor 108 may be a one-dimensional vector having a plurality of elements with each element being a feature of the article. For example, the feature vector may be of the form [f₁, f₂, f₃, . . . fₙ] representing n features of the article.

In some embodiments, the feature extractor 108 may comprise an algorithm that may receive a single sensor measurement as input and produces a feature vector comprising a single feature of the article that may be input to aggregator 110. In some embodiments, the feature extractor 108 may be a trained machine learning model that is trained to receive an input representing the sensor measurement(s) 106 and to produce a feature vector of the article that may be input to aggregator 110. For example, in some embodiments, the feature extractor 108 may be a neural network that may include one or more convolutional kernels or attention maps. In some embodiments the feature extractor 108 may be a support vector machine.

In some embodiments, the feature extractor 108 may generate a feature vector that is a single value. For example, the generated feature vector may be a positive number indicating a predicted time until the article fails. In some embodiments, the feature extractor 108 may generate a feature vector that is a member of the set {0, 1}, indicating whether the article is faulty or anomalous, for example. In some embodiments, the feature extractor 108 may generate a feature vector that indicates a type of anomaly or failure. For example, the generated feature vector may be a member of the set {0, a₁, a₂, a₃ . . . , aₙ} where 0, a₁, a₂, a₃ . . . , aₙ are each a type of anomaly or failure of the article. In some embodiments, the feature vector many include a plurality of value with each of the plurality of values is a member of the set {0, 1}, indicating whether a particular feature is present.

In some embodiments, the aggregator 110 receives a feature vector of an article that is generated by the feature extractor 108 and receives an encoding of time series data from the encoder 104. In FIG. 1, the manufacturing data 102 are measurements that may be taken by one or more sensors at one or more stations of a facility performing the manufacturing process. There may be a plurality of kinds or types of sensors measuring a plurality of characteristics of the article being manufactured. For example, the plurality of sensors may include cameras that capture imagery data; audio equipment that capture audio data; and sensors that capture data related to characteristics of the article, such as dimensions, strength, roughness, or temperature of the article during the manufacturing process. The manufacturing data 102 may be provided to the encoder 104, which may generate an encoding of the manufacturing data 102.

The manufacturing data 102 represents a history of measurements of articles captured during a manufacturing process of the articles. The manufacturing data 102 may include a sequence of measurements M related to articles captured at different stations prior to the station at which the sensor measurement(s) 106 is/are captured. For example, measurements Mᵢ₋₁ may be represented as Mᵢ₋₁={m₁, m₂, m₃, . . . , mₙ} with each measurement mᵢ being captured at a station Sᵢ₋₁ at a time when the article being measured was at Sᵢ₋₁. Thus, for a particular article X, M₁ is captured at station S₁, M₂ is captured at station S₂, . . . , and Mᵢ₋₁ is captured at station Sᵢ₋₁. Accordingly, manufacturing data 102 may include data [{M₁, M₂, M₃, . . . , Mᵢ₋₁}, {S₁, S₂, . . . , Sᵢ₋₁}, Tₓ] for each type Tₓ of an article where {S₁, S₂, . . . , Sᵢ₋₁} is a sequence of stations in the order at which an article is measured with Sᵢ being the first station in the sequence and Sᵢ₋₁ being the last station in the sequence.

For each feature vector F generated by feature extractor 108 based on sensor measurements 106 related to an article X captured at a station Sᵢ, the encoder 104 may generate an encoding of time series data related to the article X from the manufacturing data 102. For a feature vector F generated by the feature extractor 108 based on sensor measurement(s) 106 related to articles of type Tₓ at station Sᵢ₋₁, the encoder 104 may generate an encoding representing the data ({M₁, M₂, M₃, . . . , Mᵢ₋₁}, {S₁, S₂, . . . , Sᵢ₋₁}, and Tₓ) with each of the sensor measurements Mₙ being captured at a station Sn when an article of type Tₓ was at station Sn and with Tₓ being the type of the article X. In some embodiments, an encoding generated by encoder 104 is a one-dimensional vector that is an encoding of [{M₁, M₂, M₃, . . . , Mᵢ₋₁}, {S₁, S₂, . . . , Sᵢ₋₁}, Tₓ] to predict the measurements Mᵢ of the article X at station Sᵢ. In some embodiments the encoder 104 may generate an encoding that is a one-dimensional vector representing data including ({Mᵢ, Sᵢ}) where Mᵢ are one or more predicted measurements of the article X at station Sᵢ.

The one or more sensors capturing the sensor measurement(s) 106 at a particular station may include one or more sensors that are not included in the one or more sensors that capture the history of sensor measurements. In some embodiments, stations in the sequence of stations {S₁, S₂, . . . , Sᵢ₋₁} may not use one or more sensors that a station Sᵢ uses. For example, station Sᵢ may use a camera that captures a 3-dimensional image (i.e., a measurement) of an article and the sequence of stations {S₁, S₂, . . . , Sᵢ₋₁} may use only sensors that capture one-dimensional data (i.e., a single value) or two-dimensional data (e.g., a 2-dimensional image).

The aggregator 110 may receive a feature vector Fᵢ of an article X of type Tₓ based on sensor measurement data 106 related to the article X captured at a station Sᵢ. As disclosed above, the feature vector Fᵢ may be a one-dimensional vector including one or more values. The aggregator 110 may receive an encoding Eᵢ₋₁ of times series data representing a history of sensor measurements of articles of type Tₓ captured at stations prior to Sᵢ. In some embodiments, the encoding Eᵢ₋₁ may be a one-dimensional vector as described above. The aggregator 110 may aggregate the classification Ct and the encoding Eₜ₋₁ to generate an output to be included in an input to a classifier 122 included in the machine learning system 120. In some embodiments, the feature vector Fᵢ and the encoding Eₜ₋₁ are both one-dimensional vectors and the aggregator 110 generates a one-dimensional vector [Fᵢ, Eᵢ₁] that is a concatenation of Fᵢ and Eᵢ₁.

The classifier 122 may be trained using a supervised learning technique. In some embodiments, the classifier 122 comprises a neural network, such as a convolutional neural network, for example. In some embodiments, the classifier 122 comprises a support vector machine.

In some embodiments, the classifier 122 is trained by the machine learning system 120. The machine learning model 120 may be trained using training data including a plurality of training data pairs. The plurality of training data pairs may be generated by the machine learning system. Each of the plurality of training data pairs may include an input to the classifier 122 and an output from the classifier 122, wherein the output is a predetermined output that the classifier 122 is being trained to produce when the classifier 122 is applied to the input. Each input in each of the plurality of training data pairs may include an aggregation of 1) a feature vector Ft of an article of manufacture of type Tₓ based on one or more measurements related to the article captured at a particular station Sᵢ of a manufacturing process and 2) an encoding Eₜ₋₁ of time series data representing a history of measurements of articles of type TX captured at a sequence of stations of the manufacturing process prior to the station Sᵢ. The machine learning system 120 may train the classifier 122 by iteratively adjusting parameters of the classifier 122 to reduce an error in the outputs of the classifier 122 calculated when the inputs of the plurality training data pairs are input into the classifier 122. In some embodiments, the error is reduced by minimizing a loss function. For example, the parameters of the classifier 122 may be iteratively adjusted during the minimizing of a loss function. In some embodiments, the classifier 122 comprises a neural network, such as a convolutional neural network, and the error is reduced by performing a backpropagation algorithm on the neural network. In some embodiments, the classifier 122 is a support vector machine. In some embodiments, the support vector machine is trained by optimizing an objective function including a loss term and a regularizing or normalizing term.

The machine learning system 120 may include a trained classifier 122. In some embodiments, the machine learning system 120 may receive an aggregate pair related to an article, such as the aggregated pair [Fᵢ, Eᵢ₁] disclosed above. The machine learning system 120 may provide the aggregated pair as input to the trained classifier 122 to generate an output that is a predicted class of the article. In some embodiments, the machine learning system 120 may output the second classification as the predicted class 130.

In some embodiments, the classifier 122 may generate a predicted class that is a single value. For example, the predicted class may be a positive number indicating a predicted time until the article fails. In some embodiments, the classifier 122 may be a binary classifier that generates a predicted class that is a member of the set {0, 1}, indicating whether the article is faulty or anomalous, for example. In some embodiments, the classifier 122 may generate a predicted class that indicates a type of anomaly or failure of the article. For example, the predicted class may be a member of the set {0, a₁, a₂, a₃ . . . , aₙ} where 0, a₁, a₂, a₃ . . . , aₙ are each a type of anomaly or failure of the article.

In some embodiments, the predicted class output by the classifier 122 may be used by a controller in the manufacturing process of the article. In some embodiments, the machine learning system 120 may also be the controller. For example, a controller at a station Sᵢ in the manufacturing process may receive the predicted class and determine that the article is a failure (e.g., is defective) or an anomaly and direct the manufacturing process to automatically send the article to a station Sᵢ₊₁ to allow a human inspector to personally inspect the article.

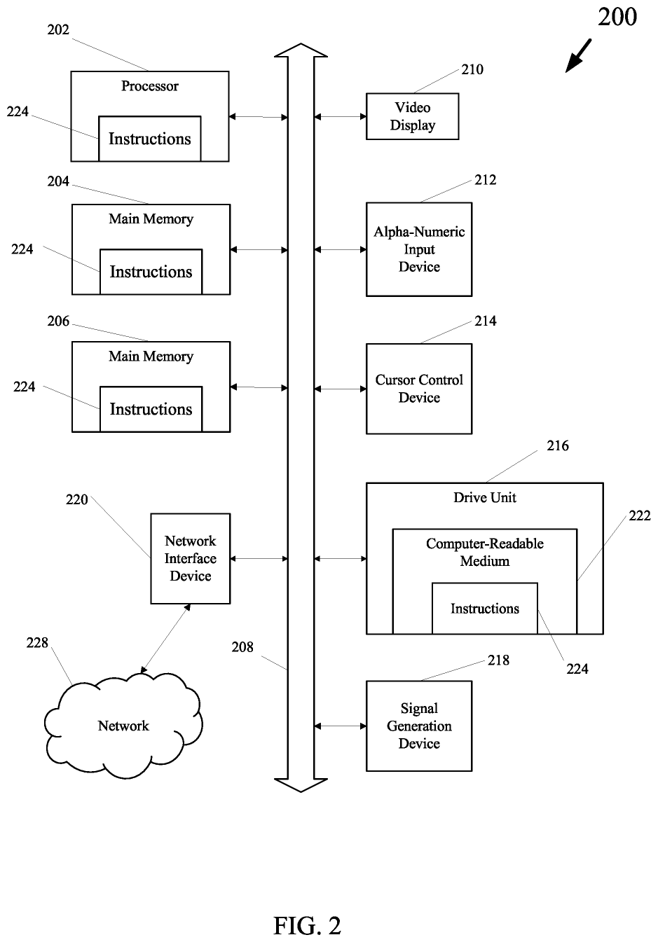

FIG. 2 shows a block diagram of an example embodiment of a general computer system 200. The computer system 200 can include a set of instructions that can be executed to cause the computer system 200 to perform any one or more of the methods or computer-based functions disclosed herein. For example, the computer system 200 may include executable instructions to perform the function of encoder 104, feature extractor 108, aggregator 110, machine learning system 120, and classifier 122. The computer system 200 may be connected to other computer systems or peripheral devices via a network. Additionally, the computer system 200 may include or be included within other computing devices.

As illustrated in FIG. 2, the computer system 200 may include one or more processors 202. The one or more processors 202 may include, for example, one or more central processing units (CPUs), one or more graphics processing units (GPUs), or both. The computer system 200 may include a main memory 204 and a static memory 206 that can communicate with each other via a bus 208. As shown, the computer system 200 may further include a video display unit 210, such as a liquid crystal display (LCD), a projection television display, a flat panel display, a plasma display, or a solid-state display. Additionally, the computer system 200 may include an input device 212, such as a remote-control device having a wireless keypad, a keyboard, a microphone coupled to a speech recognition engine, a camera such as a video camera or still camera, or a cursor control device 214, such as a mouse device. The computer system 200 may also include a disk drive unit 216, a signal generation device 218, such as a speaker, and a network interface device 220. The network interface 220 may enable the computer system 200 to communicate with other systems via a network 228. For example, the network interface 220 may enable the machine learning system 120 to communicate with a database server (not show) or a controller in a manufacturing system (not shown).

In some embodiments, as depicted in FIG. 2, the disk drive unit 216 may include one or more computer-readable media 222 in which one or more sets of instructions 224, e.g., software, may be embedded. For example, the instructions 224 may embody one or more of the methods or functionalities, such as the methods or functionalities disclosed herein. In a particular embodiment, the instructions 224 may reside completely, or at least partially, within the main memory 204, the static memory 206, and/or within the processor 202 during execution by the computer system 200. The main memory 204 and the processor 202 also may include computer-readable media.

In some embodiments, dedicated hardware implementations, such as application specific integrated circuits, programmable logic arrays and other hardware devices, can be constructed to implement one or more of the methods or functionalities described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the system 200 may encompasses software, firmware, and hardware implementations, or combinations thereof.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing or encoding a set of instructions for execution by a processor or that cause a computer system to perform any one or more of the methods or functionalities disclosed herein.

In some embodiments, some or all of the computer-readable media will be non-transitory media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A method for classifying an article of manufacture, comprising:
receiving measurements related to an article of manufacture, the measurements being captured at a first station in a manufacturing process;
applying a feature extractor to the received measurements to generate a feature vector of the article;
aggregating the feature vector of the article with encoded time series data representing a history of measurements of articles of a same type as the article of manufacture captured at a sequence of stations of the manufacturing process prior to the first station to generate an input to a classifier; and
applying a classifier to the input to produce a predicted class of the article of manufacture.

2. A method according to claim 1, wherein the one or more measurements captured at the first station are captured by one or more sensors at the first station and wherein measurements in the history of measurements are captured by one or more sensors at each of the stations in the sequence of stations.

3. A method according to claim 1, wherein the classifier is a neural network.

4. A method according to claim 3, wherein the neural network is a convolutional neural network.

5. A method according to claim 1, wherein the classifier is a support vector machine.

6. A method according to claim 1, wherein the encoded time series data includes one or more predicted measurements of the article at the first station.

7. A system for classifying an article of manufacture, comprising:
one or more processors; and
one or more non-transitory memories communicatively connected to the one or more processors, the one or more memories including computer-executable instructions that when executed cause the system to perform the following functions:
receiving measurements related to an article of manufacture, the measurements being captured at a first station in a manufacturing process;
applying a feature extractor to the received measurements to generate a feature vector of the article;
aggregating the feature vector of the article with encoded time series data representing a history of measurements of articles of a same type as the article of manufacture captured at a sequence of stations of the manufacturing process prior to the first station to generate an input to a classifier; and
applying a classifier to the input to produce a predicted class of the article of manufacture.

8. A system according to claim 7, further comprising:
one or more sensors that produce the sensor measurement data;
a feature extractor that outputs a feature vector of the article when the feature extractor is applied to the received measurements;
an aggregator that aggregates the feature vector with the encoded time series data to generate input data; and
a classifier that outputs the predicted class when the classifier is applied the input data.

9. A method for training a classifier to classify articles of manufacture, comprising:
generating training data for the classifier, the training data including a plurality of training data pairs, wherein each of the plurality of training data pairs includes an input to the classifier and a predetermined output that the classifier is being trained to produce when the classifier is applied to the input, and wherein each input in the plurality of inputs in the plurality of training data pairs includes an aggregation of:
a feature vector of an article of manufacture based on one or more measurements related to the article captured at a first station of a manufacturing process; and
encoded time series data representing a history of measurements of articles of a same type as the article of manufacture captured at a sequence of stations of the manufacturing process prior to the first station; and
iteratively adjusting parameters of the classifier by reducing an error in the outputs of the classifier generated when the classifier is applied to each of the inputs in the training data pairs.

10. A method according to claim 9, wherein the one or more measurements captured at the first station are captured by one or more sensors at the first station and wherein measurements in the history of measurements are captured by one or more sensors at each of the stations in the sequence of stations.

11. A method according to claim 10, wherein the one or more sensors capturing the measurements at the first station include one or more sensors that are not included in the sensors that capture the history of measurements at the stations in the sequence of stations.

12. A method according to claim 9, wherein the feature extractor is a neural network.

13. A method according to claim 12, wherein the neural network is a convolutional neural network.

14. A method according to claim 9, wherein the feature extractor is a support vector machine.

15. A method according to claim 9, wherein the feature vector is a one-dimensional vector including a plurality of elements.

16. A method according to claim 9, wherein the encoded time series data includes one or more predicted measurements of the article at the first station.

17. A method according to claim 9, wherein the classifier is a neural network.

18. A method according to claim 17, wherein the neural network is a convolutional neural network.

19. A method according to claim 9, wherein the classifier is a support vector machine.

20. A system for training a classifier, comprising:
one or more processors; and
one or more non-transitory memories communicatively connected to the one or more processors, the memory including computer-executable instructions that when executed cause the following functions to be performed:
generating training data for the classifier, the training data including a plurality of training data pairs, wherein each of the plurality of training data pairs includes an input to the classifier and a predetermined output that the classifier is being trained to produce when the classifier is applied to the input, and wherein each input in the plurality of inputs in the plurality of training data pairs includes an aggregation of:
a feature vector of an article of manufacture based on one or more measurements related to the article captured at a first station of a manufacturing process; and
encoded time series data representing a history of measurements of articles of a same type as the article of manufacture captured at a sequence of stations of the manufacturing process prior to the first station; and
iteratively adjusting parameters of the classifier by reducing an error in the outputs of the classifier generated when the classifier is applied to each of the inputs in the training data pairs.
